(19) United States
(12) Patent Application Publication
(10) Pub. No.: US 2007/0245634 A1
(43) Pub. Date: Oct. 25, 2007

(54) Weather strip

(75) Inventors: Kisato Oba, Aichi-ken (JP); Masahiro Nozaki, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD., Aichi-ken (JP)

(21) Appl. No.: 11/723,953

(22) Filed: Mar. 22, 2007

(30) Foreign Application Priority Data
Mar. 23, 2006 (JP) P-2006-080963
Mar. 23, 2006 (JP) P-2006-080986

(51) Int. Cl. E06B 7/22

(52) U.S. Cl. 49/498.1

(57) ABSTRACT

There is provided a weather strip in which a mounting base portion of the weather strip includes a portion formed into a substantially L-shape in cross section which has at least a bottom wall and an exterior side wall. A pressure sensitive adhesive double coated tape is securely affixed to an internal surface of the exterior side wall. A stretch and contraction prevention portion is formed on the exterior side wall in a position which lies more centrally in a width direction of the exterior side wall than a connecting portion where the exterior side wall and the bottom wall are connected together. When the mounting base portion is curved in the width direction, a neutral plane of the curve is made to reside within the stretch and contraction prevention portion.

### BACKGROUND OF THE INVENTION

1. Field of the Invention

The present invention relates to a weather strip which forms a seal between an open/close member such as an automotive door, a trunk lid and a sliding roof which covers and uncovers a body opening and a body opening portion.

2. Related Art

Hereinafter, the invention will be described by taking for example an opening trim weather strip 10 which forms a seal between a door 2 and a body opening portion 6 of an automobile.

Conventionally, a seal between the door 2 and the body opening portion 6 of the automobile is, as is shown in FIG. 8, accomplished by a door weather strip 160 which is mounted on an outer peripheral retainer 4 of a door frame of the door 2, a glass run 150 which is mounted in an inner peripheral channel 3 of the door frame, and an opening trim weather strip 110 which is mounted on a flange 7 of the body opening portion 6.

Note that the flange 7 is provided with an outer panel 9 which specifies the body opening portion 6, an inner panel 8 which lies inwards of the vehicle and the like.

In the glass run 150, a peripheral edge portion of a door glass 5 is accommodated in an interior of the glass run 150 which is defined by an exterior side wall 151, a bottom wall 152 and an internal side wall in such a manner as to be formed into a substantially U-shape in cross section, and the edge portion of the door glass 5 is held securely for seal by an exterior seal lip 154 and an internal seal lip 155 which are provided to extend from distal ends of the exterior side wall 151 and the internal side wall 153, respectively.

The door weather strip 160 which is mounted on an outer periphery of the door 2 is provided with a mounting base portion 161, a hollow seal portion 164 which is formed integrally on an upper portion of the mounting base portion and a seal lip portion 166. The mounting base portion 161 is fitted in the retainer 4 provided on the outer periphery of the door frame so as to be fixed to the door frame. Then, when the door 2 is closed, the seal lip portion 166 is brought into abutment with an outermost side edge of the body opening portion 6 so as to seal a gap between a distal edge of the door frame and the exterior side edge of the body opening portion 6. As this occurs, the hollow seal portion 164 is brought into abutment with an extending portion on the body opening portion 6 which lies on an interior side of the vehicle than the portion with which the seal lip portion 166 is brought into abutment, so as to form a seal between the door 2 and the body opening portion 6.

In the opening in the body, the opening trim weather strip 110 is mounted on the flange 7, so as to form a seal between the door 2 and the body opening portion 6 in a position which lies on an interior side of the vehicle than the portion where the body opening portion 6 is sealed by the weather strip 160. The opening trim weather strip 110 is mounted on the flange 7 at a mounting base portion 120 having a substantially U-shaped cross section, and a hollow seal portion 130 is brought into abutment with a door frame extending portion 2a for seal. For this mounting base portion 120 to grip on the flange 7, a core material 124 such as a metal insert is embedded therein, and flange holding lips are provided in an interior thereof.

However, the weight of the opening trim weather strip is increased because it has the metal insert, and force is necessary to fit the mounting base portion 120 on the flange 7 such that the flange 7 is inserted into the mounting base portion 120, whereby some labor hours are necessary to obtain a proper mounting, resulting in poor workability.

In addition, when the opening trim weather strip 110 is mounted on the entire periphery of the body opening portion 6, the thickness of the flange 7 of the body opening peripheral edge 6 varies depending upon locations thereon. Namely, while the flange 7 is made by joining together distal edges of a plurality of panels which constitute the body of the vehicle, the number of panels that are joined together varies from two to on the order of five depending upon locations, and hence the thickness of the flange 7 varies from 1.4 mm to on the order of 8 mm.

Because of this, in the event that the mounting base portion 120 is formed into the substantially U-shape in cross section and the reinforcing metal insert for holding the flange 7 is embedded in the interior of the mounting base portion 120 as the core material 124, there has occurred a case where the insertion force becomes larger or a gripping force with which the flange 7 is gripped becomes smaller depending upon locations. Consequently, to deal with these drawbacks, the hardness and shape of the holding lips formed in the interior of the mounting base portion 120 have been devised variously, but no sufficiently acceptable results have ever been provided. In addition, when the metal insert is used, the weight of the opening trim weather strip 110 is increased, which has been found not preferable in decreasing the weight of a vehicle.

In these circumstances, there is proposed an opening trim weather strip as is shown in FIG. 9 in which a core material 124 such as a metal insert is deleted from a mounting base portion (a trim portion) 220 so as to reduce the weight and enhance the pliability thereof, and a pressure sensitive adhesive double coated tape 225 is used to mount the mounting base portion 220 on a flange 7 (refer to, for example, JP-A-5-338567, JP-A-2000-335460, JP-A-11-42984 and JP-A-2001-18732).

In this case, the pressure sensitive adhesive double coated tape 225 is mounted on an inner surface of an exterior side wall 222 of the trim portion 220 of the opening trim weather strip 210, and the flange 7 is inserted into the trim portion 220, the pressure sensitive adhesive double coated tape 225 being secured to an exterior side surface of the flange 7 under pressure.

As this occurs, one of side walls of the trim portion 220 is formed shorter, and the pressure sensitive adhesive double coated tape 22 is securely affixed to the other longer side wall. A distal edge of the flange 7 is inserted deep into the trim portion 220, and the trim portion 220 is rotated in a direction indicated by an arrow so that the pressure sensitive adhesive double coated tape 225 is bonded to the side surface of the flange 7, whereby the opening trim weather strip 210 is mounted properly. When the opening trim weather strip 210 is mounted on the flange 7 with the pressure sensitive adhesive double coated tape 225, a protection tape of the pressure sensitive adhesive double coated tape 225 is peeled off, and the flange 7 is inserted into the interior of the trim portion 220, so that the pressure sensitive adhesive double coated tape 225 is secured to the side surface of the flange 7 under pressure. As this occurs, the distal edge of the flange 7 is brought into contact with the pressure sensitive adhesive double coated tape 225, leading to a case where the pressure sensitive adhesive double coated tape 225 is separated from the side wall of the trim portion 220 or the flange 7 is not inserted deeply enough into the trim portion 220 but is caused to adhere to the pressure sensitive adhesive double coated tape 225 halfway down to the bottom of the trim portion 220.

Further, in a case where the trim portion 220 is mounted on the flange 7 with the pressure sensitive adhesive double coated tape 25 without provided the core material such as the metal insert on the trim portion 220, when the trim portion 220 is mounted along the entire periphery of the peripheral edge 6 of the body opening which is an opening in a door portion of the body, the opening trim weather strip 210 stretches or contracts in the longitudinal direction, whereby there has occurred a case where part of the opening weather strip 210 is wrinkled to be distended along the body opening portion 6 or a gap is produced between one end portion and the other end portion of the opening trim weather strip 21. Because of this, as is shown in FIG. 10, there has been proposed a technique in which a core wire 222 such as a metal wire or glass fiber is embedded in the trim portion 220.

In addition, in FIG. 10, reference numeral 226 denotes an interior lip which extends inwards from the mounting base portion 221 to thereby be brought into abutment with a ceiling member or the like.

In the event that the core wire 222 is embedded in the way described above, however, although the trim portion 220 can be bent flexibly, the stretch and contraction in the longitudinal direction are completely disabled from an initial stage.

On the other hand, when the opening trim weather strip 210 is mounted on the body opening portion 6, since the opening trim weather strip 210 is mounted by being bent to match the shape of the body opening portion 6 while being pulled using a mounting jig, with the trim portion 220 made to stretch slightly, the pliability thereof is increased to ease the mounting.

Furthermore, the flange 7 is formed by joining the distal edges of the outer panel 9, which defines the body opening portion 6, and the inner panel 8, which lies inwards of the vehicle, through spot welding, and in the body opening portion 6, a cavity is formed between the outer panel 9 and the inner panel 8 in the vicinity of the flange 7 along the entire periphery of the body opening portion 6. Noises such as wind noise, tire noise and noise reflected from the road surface are transmitted through the cavity so formed along the entire periphery of the body opening portion 6. Gaps are formed in the flange 7 due to irregularities produced by the welding and irregularities produced in the distal edge portion thereof as a result of sheet metal working. Then, the noises are allowed to leak from the gaps so formed into an interior of the passenger compartment.

To cope with this, there is proposed a technique in which the distal edge of a flange 7 is held in an interior of a trim portion 220, and a sponge member is provided on a bottom wall 226, so as to enclose the distal edge of the flange 7 by the trim portion 220 and the sponge member to seal it (refer, for example, to JP-A-2000-219048).

When a trim portion 220 like this is formed, with the thickness of the flange 7 varying in the way described above, it was not possible to hold sufficiently the distal edge of the flange 7. To cope with this, a configuration is now under study in which the trim portion 220 is formed into a substantially L-shape in cross section by the bottom wall 226 and an exterior side wall 222, and the distal edge of the flange 7 is held by the bottom wall 226 which is formed into a flat plane. However, when the trim portion 220 so formed is mounted in a corner portion in the open/close member or the body opening portion 6, the trim portion 226, which is formed into the substantially L-shape by the bottom wall 226 and the exterior side wall 222, is caused to open at an obtuse angle, leading to a case where the sponge member on the bottom wall 226 is separated apart from the distal edge of the flange 7. There has occurred a case where a sufficient seal has been unable to be obtained between the distal edge of the flange 7 and the trim portion 222 as a result of the separation so occurring therebetween.

### SUMMARY OF THE INVENTION

In view of these situations, an object of the invention is to provide a weather strip which can ensure the prevention of intrusion of noise from a flange formed along a body opening portion into a passenger compartment of a vehicle even though the weather strip is mounted in a corner portion.

Another object of the invention is to provided a weather strip which can ease mounting work by controlling longitudinal stretch and contraction thereof and prevent the intrusion of noise from a flange reliably even though it is mounted in an corner portion.

With a view to solving the problem, according to a first aspect of the invention, there is provided a weather strip for establishing a seal between an open/close member and a body opening portion in an automobile, including:

a mounting base portion mounted on a flange provided on either of the open/close member and the body opening portion and a seal portion provided integrally on the mounting base portion and adapted to be brought into abutment with the other of the open/close member and the body opening portion so as to establish a seal between the open/close member and the body opening portion,

wherein the mounting base portion includes a portion formed into a substantially L-shape in cross section which has at least a bottom wall and an exterior side wall, and

a pressure sensitive adhesive double coated tape is affixed to an internal surface of the exterior side wall, a stretch and contraction prevention portion is formed on the exterior side wall in a position in the exterior side wall so as to be adjacent to a connecting portion between the exterior side wall and the bottom wall, and

when the mounting base portion is curved in the width direction, a neutral plane of the curve is made to reside within the stretch and contraction prevention portion.

In the first aspect of the invention, the weather strip has the mounting base portion mounted on the flange provided on either of the open/close member and the body opening portion and the seal portion provided integrally on the mounting base portion and adapted to be brought into abutment with the other of the open/close member and the body opening portion so as to establish a seal between the open/close member and the body opening portion. Because of this, when the mounting base portion is mounted on the outer periphery of the door frame or the body opening portion, the seal portion is brought into abutment with the body opening portion or the open/close member so as to form a seal between the open/close member and the body opening portion when the open/close member is closed.

Since the mounting base portion includes the portion formed into the substantially L-shape in cross section which has at least the bottom wall and the exterior side wall and the pressure sensitive adhesive double coated tape is securely affixed to the internal surface of the exterior side wall, even though the thickness of the flange varies, the exterior side wall can be mounted on the side surface of the flange reliably irrespective of the thickness of the flange by utilizing the pressure sensitive adhesive double coated tape. In addition, the distal edge of the flange is held by the exterior side wall and the bottom wall which is formed integrally into the substantially L-shape in cross section, so as to seal off the distal edge of the flange to thereby prevent the intrusion therefrom of noise and rain water into the interior of the vehicle.

The stretch and contraction prevention portion is formed on the exterior side wall in the position which lies more centrally in the width direction of the exterior side wall than the connecting portion where the exterior side wall and the bottom wall are connected together, and when the mounting base portion is curved in the width direction, the neutral plane of the curve is made to reside within the stretch and contraction prevention portion. Because of this, when the mounting base portion is mounted in the corner portion to thereby be curved, a force is applied in such a manner that portions of the exterior side wall are caused to stretch and contract about the stretch and contraction prevention portion so that a side end portion of the exterior side wall which continues to the bottom wall is compressed. Because of this, the bottom wall is flexed in the direction of the flange so as to be brought into pressure contact with the distal edge of the flange, the sealing properties between the distal edge of the flange and the bottom wall being thereby enhanced.

According to a second aspect of the invention, there is provided a weather strip according to the first aspect of the invention, wherein the stretch and contraction prevention portion is formed of a hard material and thicker than any other portions of the exterior side wall.

In the second aspect of the invention, since the stretch and contraction prevention portion is formed of the hard material and thicker than any other portions of the exterior side wall, the stretch and contraction prevention portion is made to stretch and contract less than the other portions of the exterior side wall, and when the mounting base portion is mounted in a corner portion to thereby be curved, the stretch and contraction prevention portion coincides with the neutral plane of the curve reliably.

According to a third aspect of the invention, there is provided a weather strip according to the first aspect of the invention, wherein a reinforcing thread material or metal wire is embedded in the stretch and contraction prevention portion.

In the third aspect of the invention, the reinforcing thread material or metal wire is embedded in the stretch and contraction prevention portion, the stretch and contraction prevention portion is made to stretch and contract less, and when the mounting base portion is mounted in a corner portion to thereby be curved, the stretch and contraction prevention portion coincides with the neutral plane of the curve reliably.

In the case of the metal wire being embedded, since the adhesion to the weather strip is secured through the treatment using an adhesive and extension and contraction are suppressed to a lower level while strength is enhanced, the extension and contraction of the weather strip can be suppressed. In the case of the reinforcing thread, since the pliability is provided and extension and contraction are suppressed to a lower level while strength is enhanced, the extension and contraction of the weather strip can be suppressed.

According to a fourth aspect of the invention, there is provided a weather strip according to any of the first to third aspects of the invention, wherein the stretch and contraction prevention portion on the exterior side wall and the bottom wall are formed of the same material whose hardness is in the range of IRHD 90 to 95, and other portions of the exterior side wall than the stretch and contraction prevention portion are formed of a hard material whose hardness is in the range of IRHD 65 to 75.

In the fourth aspect of the invention, the stretch and contraction prevention portion on the exterior side wall and the bottom wall are formed of the same material whose hardness is in the range of IRHD 90 to 95, and other portions of the exterior side wall than the stretch and contraction prevention portion are formed of the hard material whose hardness is in the range of IRHD 65 to 75. Because of this, when the mounting base portion is mounted in a corner portion to thereby be curved, a distal edge side of the exterior side wall is caused to stretch, so that the stretch and contraction prevention portion coincides with the neutral plane of the curve reliably, and even though the distal edge of the flange is brought into abutment with a stepped portion on the bottom wall, there is no case where the bottom wall is deformed abnormally, so as to hold the distal edge of the flange properly.

According to a fifth aspect of the invention, there is provided a weather strip according to any of the first to fourth aspects of the invention, wherein almost all the exterior side wall and the bottom wall are formed of the same material whose hardness is in the range of IRHD 70 to 80.

In the fifth aspect of the invention, since almost all the exterior side wall and the bottom wall are formed of the same material whose hardness is in the range of IRHD 70 to 80, the extruding work is eased, and the pliability of the weather strip and the flange holding force of the bottom wall can be maintained.

According to a sixth aspect of the invention, there is provided a weather strip according to any of the first to fifth aspects of the invention, wherein the weather strip is formed into a ring shape so as to match the shape of the flange by connecting together both ends of a rectilinearly extruded weather strip, and wherein a connecting portion where both the ends are connected together is formed of a material which is softer than other portions of the extruded weather strip.

In the sixth aspect of the invention, the weather strip is formed into the ring shape so as to match the shape of the flange by connecting together both the ends of the rectilinearly extruded weather strip, and the connecting portion where both the ends are connected together is formed of the material which is softer than other portions of the extruded weather strip. Since the weather strip is formed into the ring shape, when mounted on the flange, the weather strip can be fitted thereon in such a way as to match the shape of the flange for temporary fitment for subsequent proper mounting.

According to a seventh aspect of the invention, there is provided a weather strip according to any of the first to sixth aspects of the invention, wherein the open/close member is a door, and the weather strip is an opening trim weather strip.

In the seventh aspect of the invention, since the open/close member is the door, and the weather strip is the opening trim weather strip, a seal can be formed between the body opening portion and the door reliably, and noise attempting to intrude into the interior of the vehicle from the gaps in the flange can be encapsulated by the mounting base portion, so as to prevent the intrusion of noise into the interior of the vehicle reliably.

In the invention, since the pressure sensitive adhesive double coated tape is secured affixed to the internal side surface of the exterior side wall, the mounting base portion can be mounted on the flange irrespective of the thickness of the flange, and a wide area can be provided for secure affixation of the pressure sensitive adhesive double coated tape, thereby making it possible to allow the mounting base portion to adhere to the flange strongly and rigidly.

The stretch and contraction prevention portion is formed on the exterior side wall in the position which lies more centrally in the width direction of the exterior side wall than the connecting portion where the exterior side wall and the bottom wall are connected together, and when the mounting base portion is curved in the width direction, the neutral plane of the curve is made to reside within the stretch and contraction prevention portion. Because of this, when the mounting base portion is mounted in the corner portion to thereby be curved, the bottom wall is flexed in the direction of the flange so as to be brought into pressure contact with the distal edge of the flange, the sealing properties between the distal edge of the flange and the bottom wall being thereby enhanced.

With a view to solving the problem, according to an eighth aspect of the invention, a twisted thread which coincides with a neutral plane of the curve when the mounting base portion is curved in a width direction is embedded continuously in the mounting base portion in a longitudinal direction.

In the eighth aspect of the invention, even though the thickness of the flange varies, the exterior side wall can be mounted on the side surface of the flange reliably irrespective of the thickness of the flange by utilizing the pressure sensitive adhesive double coated tape. In addition, the distal edge of the flange is held by the exterior side wall and the bottom wall which is formed integrally into the substantially L-shape in cross section, so as to seal off the distal edge of the flange to thereby prevent the intrusion therefrom of noise and rain water into the interior of the vehicle.

Further, since, the twisted thread which coincides with the neutral plane of the curve when the mounting base portion is curved in a width direction is embedded continuously in the longitudinal direction, when the mounting base portion of the weather strip is mounted on the flange, the twist of the twisted thread stretches to a stretchable limit and stretches no further than that. Therefore, the pliability of the mounting base is increased, whereby the mounting base portion can easily be mounted by being stretched along the flange while being deformed. The twisted thread tends to stretch less after the twist has been stretched, and the twisted thread embedded portion stretches and contracts less, whereby when the mounting base portion is mounted in the corner portion to thereby be curved, the twisted thread coincides with a neutral plane of the curve reliably, thereby making it possible to suppress the stretch of the whole of the weather strip in the longitudinal direction.

According to a ninth aspect of the invention, the weather strip is mounted on the flange which is provided on either of the open/close member and the body opening portion in such a state that the twist of the twisted thread which is embedded in the mounting base portion is stretched.

In the ninth aspect of the invention, the weather strip is mounted on the flange provided on either of the open/close member and the body opening portion in such a state that the twist of the twisted thread which is embedded in the mounting base portion is stretched. Because of this, the weather strip can be mounted in such a manner as to follow the configuration of the corner portion of the body opening portion while being stretched in the longitudinal direction when the weather strip is attempted to be mounted on the flange, whereby no wrinkle is produced in the mounting base portion at the time of mounting and even after mounted, tension is applied to make it difficult for a wrinkle to be produced in the relevant portion.

According to a tenth aspect of the invention, there is provided a weather strip according to the first or second aspect of the invention, wherein the twisted thread is a single thread made by twisting together a plurality of yarns each of which is provided with a number of thin fibers twisted together.

In the tenth aspect of the invention, since the twisted thread is the single thread made by twisting together a plurality of yarns each of which is provided with a number of thin fibers twisted together, there is produced a slight stretch when the twist is untwisted, and after the twist has been untwisted, tension on the thread is increased and stretch is decreased, whereby there preferably occurs no case where the longitudinal overall length of the weather strip stretches largely.

According to an eleventh aspect of the invention, there is provided a weather strip according to any of the first to third aspects of the invention, wherein the twisted thread lies more centrally in a width direction of the exterior side wall than a connecting portion where the exterior side wall and the bottom wall are connected together.

In the eleventh aspect of the invention, since the twisted thread lies more centrally in the width direction of the exterior side wall than a connecting portion where the exterior side wall and the bottom wall are connected together, when the mounting base portion is mounted in the corner portion to thereby be curved, the portions of the exterior side wall stretch and contract about the twisted thread, and a force is applied in a direction in which a side end portion of the exterior side wall where it continues to the bottom wall is compressed, whereby the bottom wall is deflected in the direction of the flange to thereby be brought into contact with the distal edge of the flange under pressure, the sealing properties between the distal edge of the flange and the bottom wall being thereby increased.

According to a twelfth aspect of the invention, there is provided a weather strip according to any of the first to fourth aspects of the invention, wherein the twisted thread is provided with polyester fibers, Vinylon fibers or nylon fibers.

In the twelfth aspect of the invention, since the twisted thread is provided with polyester fibers, Vinylon fibers or nylon fibers, the twisted thread has a superior pliability and stretches less in the longitudinal direction, which eases the control of stretch of the twist of the twisted thread.

According to a thirteenth aspect of the invention, there is provided a weather strip according to any of the first to fifth aspects of the invention, wherein a portion of the exterior side wall where the twisted thread is embedded is formed of a hart rubber material or thermoplastic elastomer and is formed thicker than other portions of the exterior side wall.

In the thirteenth aspect of the invention, since the portion of the exterior side wall where the twisted thread is embedded is formed of a hart rubber material or thermoplastic elastomer and is formed thicker than other portions of the exterior side wall, the portion of the mounting base portion where the twisted thread is embedded tends to stretch less compared to the other portions of the exterior side wall, whereby when the mounting base portion is mounted in the corner portion to thereby be curved, the twisted thread coincides with the neutral plane of the curve reliably.

According to a fourteenth aspect of the invention, there is provided a weather strip according to any of the first to sixth aspects of the invention, wherein a stretch and contraction prevention portion which is the portion of the exterior side wall where the twisted thread is embedded and the bottom wall are formed of a hard material whose hardness is in the range of IRHD 90 to 95, and the other portions of the exterior side wall than the stretch and contraction prevention portion are formed of a material whose hardness is in the range of IRHD 65 to 75.

In the fourteenth aspect of the invention, the stretch and contraction prevention portion which is the portion of the exterior side wall where the twisted thread is embedded and the bottom wall are formed of the hard material whose hardness is in the range of IRHD 90 to 95, and the other portions of the exterior side wall than the stretch and contraction prevention portion are formed of a material whose hardness is in the range of IRHD 65 to 75. Because of this, when the mounting base portion is mounted in the corner portion to thereby be curved, a distal edge side of the exterior side wall stretches, and the portion of the exterior side wall where the twisted thread is embedded coincides with the neutral plane of the curve reliably, whereby even though the distal edge of the flange is brought into abutment with a stepped portion on the bottom wall, the mounting base portion is deformed in no case in a direction in which the bottom wall is separated from the exterior side wall, thereby making it possible to keep holding the distal edge of the flange.

According to a fifteenth aspect of the invention, there is provided a weather strip according to any of the first to seventh aspects of the invention, wherein the open/close member is a door, and the weather strip is an opening trim weather strip.

In the fifteenth aspect of the invention, since the open/close member is the door, and the weather strip is the opening trim weather strip, a seal can be formed between the body opening portion and the door reliably, and noise attempting to intrude into the interior of the vehicle from the gaps in the flange can be encapsulated by the mounting base portion, so as to prevent the intrusion of noise into the interior of the vehicle reliably.

In the invention, since the twisted thread is embedded in the portion which coincides with the neutral plane of the curve when the mounting base portion is curved in the width direction, when the mounting base portion of the weather strip is mounted on the flange, the twist of the twisted thread stretches to its stretch limit and stretches no further than that. Therefore, the pliability of the mounting base is increased, whereby the mounting base portion can easily be mounted by being stretched along the flange while being deformed. In addition, since the twisted thread tends to stretch no further after the twist has stretched, the twisted thread embedded portion stretches and contracts less, thereby making it possible to suppress the stretch of the whole of the weather strip in the longitudinal direction.

### BRIEF DESCRIPTION OF THE DRAWINGS

FIG. 1 is a sectional view of an opening trim weather strip of a first embodiment of the invention taken along the line I-I in FIG. 5 in such a state that the opening trim weather strip is mounted on a body opening portion.

FIG. 2 is a sectional view of an opening trim weather strip of a second embodiment of the invention taken along the line I-I in FIG. 5 in such a state that the opening trim weather strip is similarly mounted on the body opening portion.

FIG. 3 is a sectional view of an opening trim weather strip of a third embodiment of the invention taken along the line I-I in FIG. 5 in such a state that the opening trim weather strip is similarly mounted on the body opening portion.

FIG. 4 is a perspective view, as viewed from the rear of an automobile, showing a way in which the opening trim weather strip is mounted on the body opening portion in such a state that a door of the automobile is left opened.

FIG. 5 is a front view of the opening trim weather strip of the embodiment of the invention.

FIG. 6 is a sectional view of an opening trim weather strip of a fourth embodiment of the invention taken along the line I-I in FIG. 5 in such a state that the opening trim weather strip is mounted on a body opening portion.

FIG. 7 is a graph showing the results of a tensile test which was carried out on a twisted thread which is embedded in the opening trim weather strip of the fourth embodiment of the invention.

FIG. 8 is a sectional view of a related-art door opening trim weather strip showing a state in which the same weather strip is mounted on an opening portion of an automobile.

FIG. 9 is a sectional view of another related-art door opening trim weather strip showing a state in which the same weather strip is mounted on a flange of the automobile by means of a pressure sensitive adhesive double coated tape.

FIG. 10 is a sectional view of another related-art door opening trim weather strip.

### DETAILED DESCRIPTION OF THE PREFERRED EMBODIMENTS

Embodiments of the invention will be described by taking for example a door and an opening trim weather strip 10. The invention can be applied to, in addition to the opening trim weather strip 10, a weather strip which has a seal portion which forms a seal between a body opening and an open/close member which covers the body opening of an automobile and a mounting base portion, the weather strip including a sliding roof weather strip, a luggage compartment weather strip, a rear door weather strip and the like.

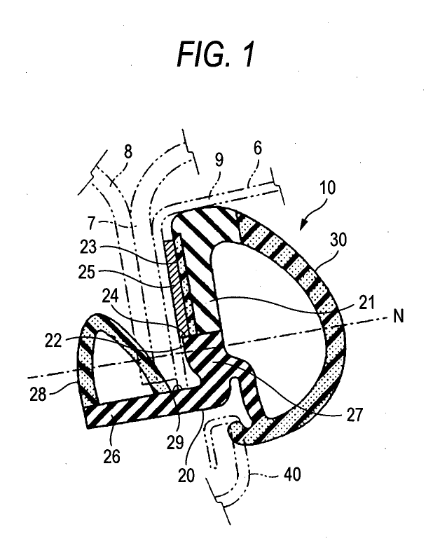

First to third embodiments of the invention will be described based on FIGS. 1 to 5.

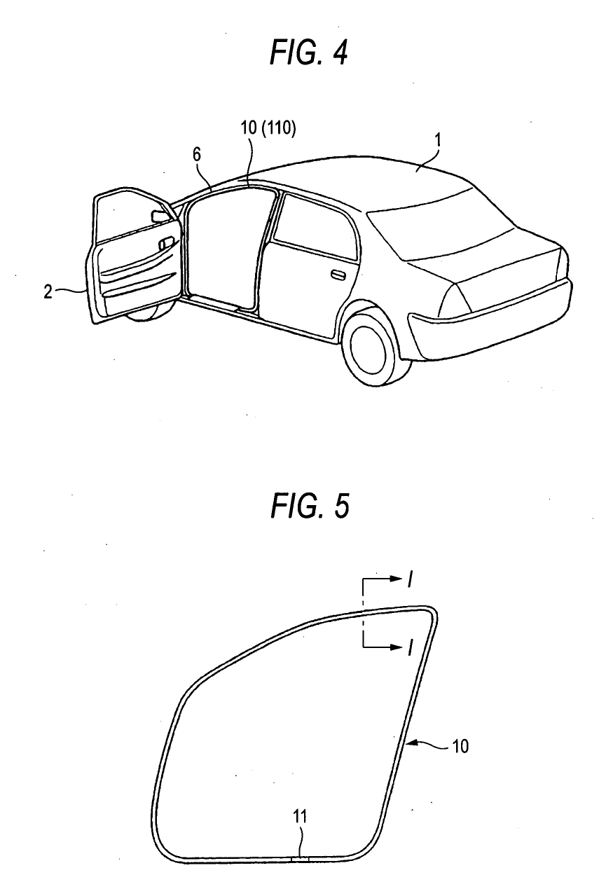

FIG. 1 is a sectional view of an opening trim weather strip 10 of a first embodiment of the invention taken along the line I-I in FIG. 5 in such a state that the opening trim weather strip 10 is mounted on a body opening portion 6 shown in FIG. 4.

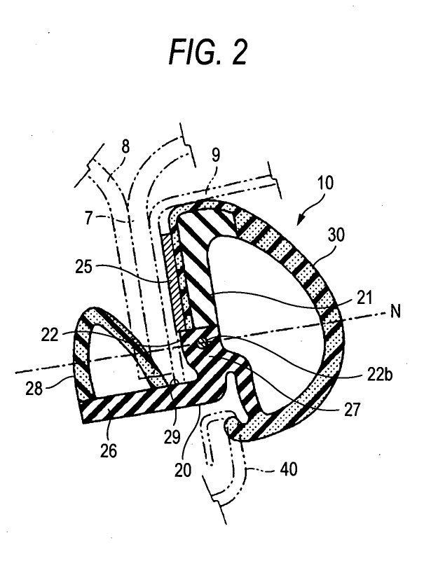

FIG. 2 is a sectional view of an opening trim weather strip 10 of a second embodiment of the invention taken along the line I-I in FIG. 5 in such a state that the opening trim weather strip 10 is similarly mounted on the body opening portion 6 shown in FIG. 4.

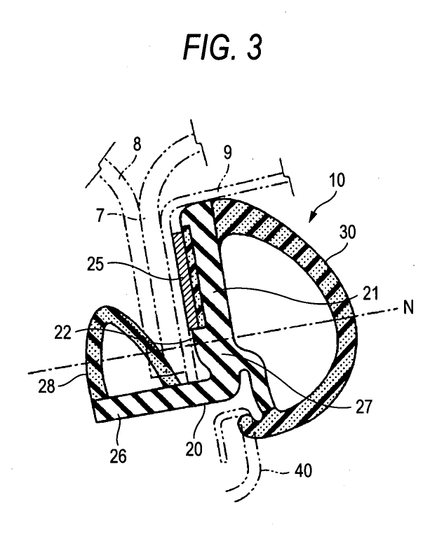

FIG. 3 is a sectional view of an opening trim weather strip 10 of a third embodiment of the invention taken along the line I-I in FIG. 5 in such a state that the opening trim weather strip 10 is similarly mounted on the body opening portion 6 shown in FIG. 4.

FIG. 4 is a perspective view showing a state in which the opening trim weather strip 10 is mounted on the body opening portion 6 in such a state that a door of an automobile is left opened. FIG. 5 is a front view of the whole of the opening trim weather strip 10 which is to be mounted on the body opening portion 6.

As is shown in FIG. 4, a body 1 of the automobile has a body opening, and the body opening is covered and uncovered by a door 2 which is an open/close member. A periphery of the body opening coincides with the body opening portion 6, and distal edges of an outer panel 9, an inner panel 8 and the like, which make up the body 1, are welded together to a distal edge of the body opening portion 6 to thereby constitute a flange (refer to FIGS. 1 to 3). The opening trim weather strip 10 is mounted on the flange 7 in such a manner as to form a seal between the body opening portion 6 and the door 2.

The flange 7 varies in thickness depending upon locations of the body 1 due to the number of panels which are welded together varying from two to on the order of five depending upon locations of the body opening portion 6 of the body 1.

The opening trim weather strip 10 is formed into a straight-line shape through extrusion. As is shown in FIG. 5, a single opening trim weather strip 10 which is extruded rectilinearly in that way is formed into a ring shape by a connecting portion 11, and is then, as is shown in FIG. 4, mounted on the flange 7 along the shape of the body opening portion 6. In addition, ends of the opening trim weather strip 10 may be bonded together with an adhesive so as to be formed into the ring shape before mounting. When formed into the ring shape, the opening trim weather strip 10 can easily be mounted on a peripheral edge of the door 2 or the body opening portion 6.

Alternatively, without connecting in advance the ends of the opening trim weather strip 10 to form it into the ring shape, the opening trim weather strip 10 may be mounted on the flange 7 sequentially from one of the ends thereof and when the opening trim weather strip 10 is mounted on the flange 7 completely, the other end is jointed to the one end of the opening trim weather strip 10.

Next, a cross-sectional configuration of the opening trim weather strip 10 of the first embodiment will be described based on FIG. 1.

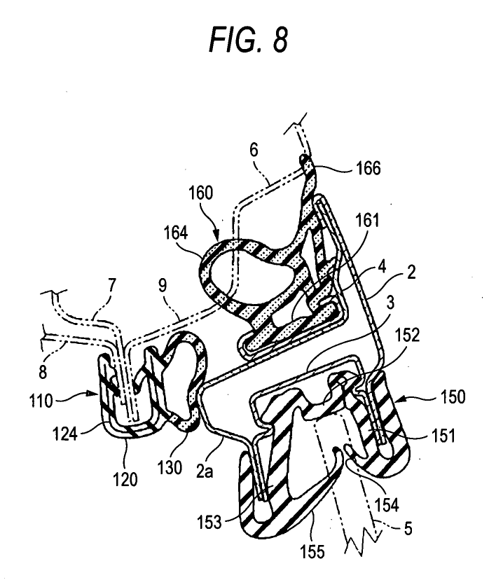

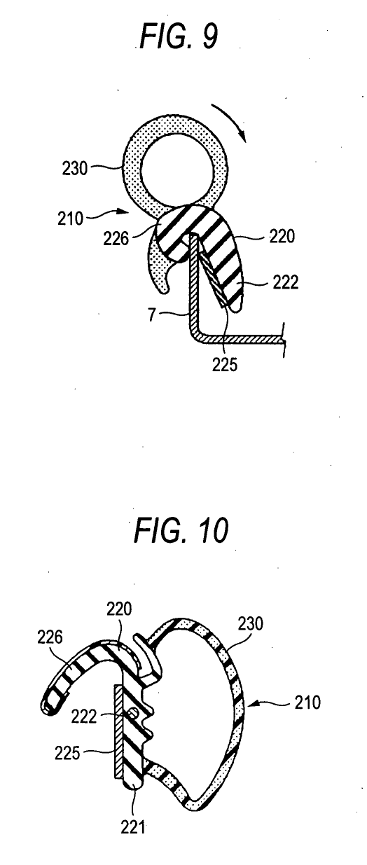

The opening trim weather strip 10 has a trim portion (a mounting base portion) 20 which is mounted on the flange 7 and is formed into a substantially L-shape in cross section and a hollowed seal portion (a hollow seal portion) 30 which is formed integrally with the trim portion 20 and which forms a seal between the door 2 and the body opening portion 6 by being brought into abutment with a door frame extending portion 2a (see FIG. 8) on the door 2.

The trim portion 20 has at least an exterior side wall 21 and a bottom wall 26 which define a substantially L-shaped cross section thereof. Since the trim portion 20 is made to deal with a variation in thickness of the flange 7, the bottom wall 26 has a predetermined width dimension. The exterior side wall 21 and the bottom wall 26 are formed integrally and continuously, and there is not embedded therein a metal plate or an insert (a core material) made of a hard synthetic resin which is intended to reinforce the holding force with which the flange 7 is held. Because of this, the weight of the opening trim weather strip 10 can be decreased.

The exterior side wall 21 is formed into a substantially flat plate shape in cross section which extends along a vertical direction of the vehicle, and a pressure sensitive adhesive double coated tape 25 is securely affixed to an internal surface of the exterior side wall 21. The exterior side wall 21 of the opening trim weather strip 10 is bonded to a side surface of the flange 7 by means of the pressure sensitive adhesive double coated tape.

With use of the pressure sensitive adhesive double coated tape 25, since the pressure sensitive adhesive double coated tape 25 only has to be bonded to the exterior surface of the flange 7, the mounting process remains the same and the adhesive force with which the tape adheres to the flange 7 also remains the same even though the thickness of the flange 7 varies, whereby the mounting is eased. In addition, with the pressure sensitive adhesive double coated tape 25 securely affixed to the exterior side wall 21, the secure affixation area is increased, whereby the trim portion 20 can be bonded to the flange 7 strongly and rigidly.

In the event that the pressure sensitive adhesive double coated tape 25 is formed of a sponge material such as an acrylic foam so as to be made thick or a sponge layer 23, which is formed of the same material as a sponge material of which the seal portion is formed, is formed between the exterior side wall 21 and the pressure sensitive adhesive double coated tape 25, the adhesion between the exterior side wall 21 and the pressure sensitive adhesive double coated tape 25 can be made strong and rigid, and the pressure sensitive adhesive double coated tape 25 is allowed to be deformed to match irregularities such as marks formed on the side surface of the flange 7 as a result of welding in such a manner as to bring the exterior side wall 21 and the flange 7 into tight contact with each other.

A side of the exterior side wall 21 which continues to the bottom wall 26 is, as will be described later on, formed integrally with the bottom wall 26 of a hard material whose hardness is in the range of IRHD 90 to 95. A stretch and contraction prevention portion 22, which is made thick, is formed at a location which deviates slightly from a portion where the exterior side wall 21 is connected with the bottom wall 26 towards a center of the exterior side wall 21 in a width direction (a vertical direction) thereof. When the trim portion 20 is mounted in a corner portion of the body opening portion 6, although the exterior side wall 21 is curved in the width direction thereof, since the stretch and contraction prevention portion 22 is formed thick of the hard material whose hardness is in the range of IRHD 90 to 95, the stretch and contraction prevention portion 22 coincides with a neutral plane N of the curve. Namely, in the corner portion, a portion of the exterior side wall 21 which lies further distal than the stretch and contraction prevention portion 22 is extend while a portion of the exterior side wall 21 which lies closer to the bottom wall 26 side than the stretch and contraction prevention portion 22 is compressed, the stretch and contraction prevention portion 22 remaining neither extended nor compressed.

Because of this, the bottom wall 26 is deflected in a direction in which it is brought into abutment with a distal edge of the flange 7, that is, the bottom wall 26 is deflected in such a manner that the angle of the L-shape cross section becomes acute, so that the bottom wall 26 is brought into pressure contact with the distal edge of the flange 7, whereby the sealing properties between the distal edge of the flange 7 and the bottom wall 26 are enhanced.

In addition, since the stretch and contraction prevention portion is formed thicker than a distal edge side portion of the exterior side wall 21, a stepped exterior side wall projecting portion 24 is formed on an internal surface thereof. When the pressure sensitive adhesive double coated tape 25 is securely affixed on the exterior side wall 21 in such a manner that a side edge thereof extends along a stepped side surface of the exterior side wall projecting portion 24, the positioning of the pressure sensitive adhesive double coated tape 25 can be implemented.

A continuous portion 27 between the exterior side wall 21 and the bottom wall 26 and the bottom wall 26, which will be described later on, are formed of the same hard material as that of the stretch and contraction prevention portion whose hardness is in the range of IRHD 90 to 95. Because of this, even though the distal edge of the flange 7 is brought into abutment with the bottom wall 26 at a straight-line portion, a risk is decreased in which the angle between the bottom wall 26 and the exterior side wall 21 is increased, thereby making it possible to secure the sealing properties between the distal edge of the flange 7 and the bottom wall 26.

A sponge layer 23 may be formed between the exterior side wall 21 and the pressure sensitive adhesive double coated tape 25 at a location on an internal surface of the exterior side wall 21 which lies further distal than the stretch and contraction prevention portion 22. As this occurs, the adhesion between the internal surface of the exterior side wall 21 and the pressure sensitive adhesive double coated tape 25 can be increased, and when the pressure sensitive adhesive double coated tape 25 is caused to adhere to the flange 7, the pressure sensitive adhesive double coated tape 25 can absorb irregularities which are provided with spot welding marks formed on the side surface of the flange 7 so that the pressure sensitive adhesive double coated tape 25 can be caused to adhere to the exterior side wall 21 strongly and rigidly.

A sponge material may be formed integrally on a distal edge of the exterior side wall 21. A distal edge of the sponge material so formed is brought into a bent portion of the outer panel 9 when the exterior side wall 21 is mounted on the flange 7, so as to form a seal between the outer panel 9 and the opening trim weather strip 10.

The portion of the exterior side wall 21 which lies further distal than the stretch and contraction prevention portion 22 is formed of a material whose hardness is in the range of IRHD 65 to 70. Because of this, as has been described above, when the trim portion 20 is mounted in the corner portion to thereby be curved, the distal side of the exterior side wall 21 is caused to stretch, and the stretch and contraction prevention portion 22 coincides with the neutral plane N of the curve reliably. Note that since the exterior side wall 21 has a sufficient hardness, the configuration thereof is stabilized, and the exterior side wall 21 can hold the hollowed seal portion 30, which will be described later on, securely so as to secure the sealing properties.

The bottom wall 26 extends from the exterior side wall 21 horizontally and substantially perpendicularly thereto in such a manner as to be formed into a substantially flat plate shape and is formed of a hard material. The hard material is formed continuously and integrally from the stretch and contraction prevention portion 22 on the exterior side wall 21 to the distal edge of the bottom wall 26.

Because of this, even though the distal edge of the flange 7 is brought into abutment with the bottom wall 26 in such a manner as to push it at the straight-line portion, the bottom wall 26 is scarcely deformed, and a position where the exterior side wall 21 is caused to adhere to the flange 7 can be determined, whereby the exterior side wall 21 can be caused to adhere to the flange 7 reliably.

In addition, an insulation sponge 28, which is an insulation member, is provided on a surface of the bottom wall 26 with which the flange 7 is brought into abutment. In this embodiment, the insulation sponge 28 is formed into a triangular hollowed shape and a distal edge of the insulation sponge 28 which lies on a root side of the bottom wall 26 is jointed to the bottom wall 26 in such a manner as to deviate slightly towards the distal edge side of the bottom wall 26 to thereby form a bottom wall stepped portion 29 where the insulation sponge 28 is not provided. Because of this, the distal edge of the outer panel 9 of the flange 7, which is formed slightly longer than the other portions, can be brought into direct abutment with the bottom wall stepped portion 29 on the bottom wall 26, whereby not only the positioning of the flange 7 can be implemented but also the position on the exterior side wall 21 where the pressure sensitive adhesive double coated tape 25 thereon is caused to adhere to the flange 7 can be determined. Note that the bottom wall stepped portion 29 may be formed into an L-shaped stepped shape in cross section on the bottom wall 26.

In addition, since the insulation sponge 28 is formed of a sponge material, portions of the flange 7 other than the portion provided with the distal edge of the outer panel 9 are embedded in the insulation sponge 28 so as to encapsulate the distal edge of the flange. Because of this, in the event that the flange 7 is made through spot welding or the like, although gaps are produced between the individual plates which make up the flange 7, the leakage of noise and rain water from the gaps in the distal edges of the constituent metal plates of the flange 7 can be prevented. In addition, dust and noise which would otherwise intrude from the outside into the interior of the vehicle by passing through between the distal edge of the flange 7 and the bottom wall 26 can also be sealed out.

As the hard material, a hard rubber or hard synthetic resin (including a hart thermoplastic elastomer) can be used. As the hard rubber, a hard EPDM rubber whose hardness is in the range of IRHD 90 to 95 can be used, and as the hard synthetic resin, a hard polyethylene or hard polypropylene can be used. Furthermore, a hard olefin-based thermoplastic elastomer whose hardness is in the range of IRHD 90 to 95 can also be used.

These hard materials stretch and contract less in the longitudinal direction, and when the opening trim weather strip 10 is mounted on the flange 7, the opening trim weather strip stretches less relative to the flange 7, so that there occurs no case where the opening trim weather strip 10 is partially separated or floated from the flange 7 or the opening trim weather strip 10 is wrinkled.

When forming an opening trim weather strip 10, in the event that as the hard material, the hard EPDM, hard polyethylene, hard polypropylene or the like is used for the portion that is to be formed of the hard material while the other portion is formed of a soft EPDM rubber or olefin-based thermoplastic elastomer which is softer than the hard material, both the materials can be formed simultaneously through extrusion using an extruding machine.

The hollowed seal portion 30 is formed integrally on an external surface of the exterior side wall 21. The hollowed seal portion 30 is formed of a hollow sponge material of a substantially oval cross section on the external surface of the exterior side wall 21. A sponge rubber, a sponge thermoplastic elastomer or the like is sued for the sponge material. The hollowed seal portion 30 is, when the door is closed, brought into abutment with, for example, the door frame extending portion 2a of the door 2 so as to form a seal between the door 2 and the body opening portion 6. A garnish may be provided in such a manner as to cover a side edge of the hollowed seal 30 and the bottom wall 26, whereby the flange 7 and the bottom wall 26 can be covered by the garnish 40 so as to enhance the aesthetic external appearance of the body opening.

When the opening trim weather strip 10 of the first embodiment is mounted on the flange 7, firstly, the trim portion 20 of the opening trim weather strip 10 is positioned obliquely relative to the flange 7, so that the distal edge of the flange 7 is brought into abutment with the bottom wall 26. As this occurs, since no internal side wall is provided on the trim portion 20, the flange 7 can be inserted into the trim portion 20 while being inclined obliquely relative to the trim portion 20.

As this occurs, since the outer panel 9 of the flange 7 is slightly longer than the other panels, the distal edge of the outer panel 9 is brought into abutment with the bottom wall stepped portion 29 on the bottom wall 26. Then, a side surface of the outer panel 9 is brought into abutment with the stretch and contraction prevention portion 22 of the exterior side wall 21.

Thereafter, the trim portion 20 is rotated, so that the pressure sensitive adhesive double coated tape 25 is pushed against the side surface of the flange 7. Then, the hollowed seal portion 30 is pressed by a roller, so that the pressure sensitive adhesive double coated tape 25 is caused to adhere to the flange 7.

Next, a sectional configuration of an opening trim weather strip 10 of a second embodiment will be described based on FIG. 2. The second embodiment differs from the first embodiment in that a reinforcing thread material 22b is embedded in a stretch and contraction prevention portion 22 of an exterior side wall 21, and hence, a different feature will mainly be described, and the description of like portions to those of the first embodiment will be omitted.

The reinforcing thread member 22b can utilize a thread made of aramid fiber, nylon fiber or polyester fiber, or a metal wire of stainless steel or copper.

Since the reinforcing thread material 22b is embedded in the stretch and contraction prevention portion 22, along with the fact that the stretch and contraction prevention portion 22 is formed of the hard material, the stretch and contraction prevention portion 22 is made to stretch and contract much less, and hence, when a trim portion 20 is mounted in a corner portion to thereby be curved, the stretch and contraction prevention portion 22 coincides with a neutral plane N of the curve of the trim portion 20 reliably. In the case of the metal wire being embedded, since the adhesion to the stretch and contraction prevention portion 22 is secured through a treatment using an adhesive while decreasing stretchability and increasing strength, the stretch and contraction of the opening trim weather strip 10 can be suppressed. In the case of the reinforcing thread material 22b, since pliability is provided while decreasing stretchability and increasing strength, the stretch and contraction of the opening trim weather strip 10 can be suppressed.

Further, in the second embodiment, a part of the hollowed seal portion 30 formed of the sponge material is extended between the exterior side wall 21 and the pressure sensitive adhesive double coated tape 25 at a location on the internal surface of the exterior side wall 21.

Next, a sectional configuration of an opening trim weather strip 10 of a third embodiment will be described based on FIG. 2. The third embodiment differs from the first embodiment in that materials of a trim portion 20 and an exterior side wall 21 are formed of the same material, and hence, a different feature will mainly be described, and the description of like portions to those of the first embodiment will be omitted.

Almost all the exterior side wall 21 and the bottom wall 26 including a stretch and contraction prevention portion 22 are formed of the same material whose hardness is in the range of IRHD 70 to 80.

Since the exterior side wall 21 and the bottom wall 26 are formed of the same material, the speed of extruding work is fast and the extruding work is eased. In addition, since the hardness of the material is in the range of IRHD 70 to 80, the pliability of the bottom wall 26 and the exterior side wall 21 and the magnitude of holding force of a flange 7 can be maintained, thereby making it possible to secure the sealing properties between an insulation sponge 28 of the bottom wall 26 and the flange 7.

In addition, since the thickness of the stretch and contraction prevention portion 22 is thick, when the opening trim weather strip 10 is mounted in a corner portion, the same weather strip stretches and contracts less, thereby making it possible to form a neutral plane of deformation.

Fourth embodiment of the invention will be described based on FIGS. 4 to 7.

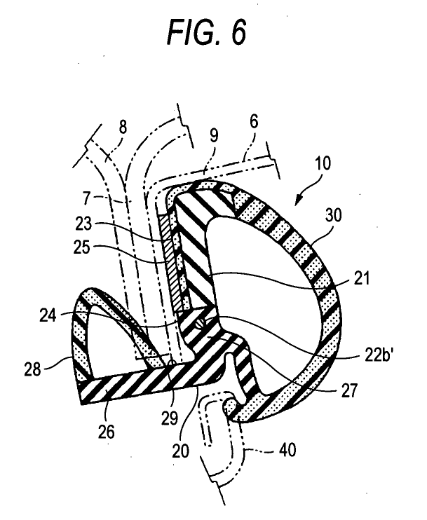

FIG. 6 is a sectional view of an opening trim weather strip 10 of a fourth embodiment of the invention taken along the line I-I in FIG. 5 in such a state that the opening trim weather strip 10 is mounted on a body opening portion 6 shown in FIG. 4.

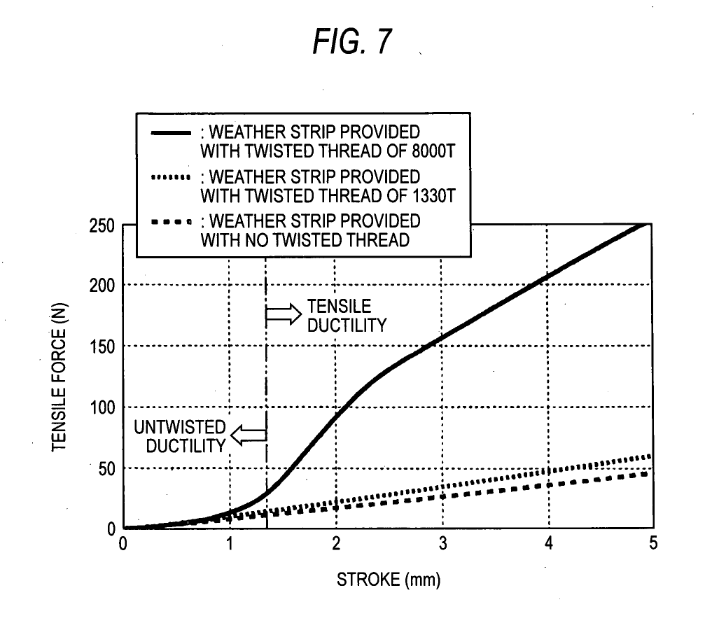

FIG. 7 is a graph showing the results of a tensile test which was carried out on an opening trim weather strip 10 in which a twisted thread 22b′ used in the invention was embedded.

The opening trim weather strip 10 of the fourth embodiment as similar structure of that of the second embodiment.

A sponge layer 23, which is made of the same material as the sponge material of the seal portion 30, can be formed between the exterior side wall 21 and the pressure sensitive adhesive double coated tape 25 at a location on an internal surface of the exterior side wall 21 which lies further distal than the exterior side wall projecting portion. As this occurs, the pressure sensitive adhesive double coated tape 25 can be caused to adhere to the exterior side wall 26 strongly and rigidly, and when the pressure sensitive adhesive double coated tape 25 is caused to adhere to the flange 7, the pressure sensitive adhesive double coated tape 25 can absorb irregularities which are provided with spot welding marks formed on the side surface of the flange 7.

A sponge material may be formed integrally on a distal edge of the exterior side wall 21. A distal edge of the sponge material so formed is brought into a bent portion of the outer panel 9 when the exterior side wall 21 is mounted on the flange 7, so as to form a seal between the outer panel 9 and the opening trim weather strip 10.

The twisted thread 22b′ as reinforcing thread material is embedded in a portion on the exterior side wall 21 which is slightly shifted from the continuous portion 27 between the exterior side wall 21 and the bottom portion 26. The twisted thread is formed by twisting fibers together and is provided with, for example, polyester fibers, Vinylon fibers or nylon fibers. These fibers have a superior pliability in the bending direction and stretch and contract less in the longitudinal direction, so that the stretch of the twist of the twisted thread 22b′ can easily be controlled. The twisted thread 22b′ may be a yarn which is provided with many thin fibers twisted together or a single thread made by twisting a plurality of such yarns.

FIG. 7 is a graph which shows a relationship between stretch and tensile force at the portion of the opening trim weather strip where the twisted thread 22b′ is embedded. This graph is such as to shown a relationship between tensile force and tensile stroke when an opening weather strip 10 is held by two chucks which were spaced 100 mm apart from each other and was tensioned at a speed of 200 mm per minute.

In FIG. 7, a solid line is such as to indicate the result of a tensile test carried out on an opening trim weather strip 10 in which a twisted thread 22b′ of 8000 T (decitex) was embedded which was provided with four yarns of 2000 T twisted together. A dotted line is such as to indicate the result of a tensile test carried out on an opening trim weather strip in which a twisted thread of 1330 T was embedded, and a broken line is such as to indicate the result of a tensile test carried out on an opening trim weather strip in which no twisted thread 22b′ was embedded.

As is shown in FIG. 7, since, when a tensile stress is applied to the twisted thread 22b′ in the longitudinal direction, initially, the twisted thread 22b′ stretches due to the twist thereof being untwisted, the twisted thread 22b′ stretches even with a small tensile stress (hereinafter, referred to as untwisted ductility) However, when the twisted thread 22b′ is stretched to exceed this untwisted ductility, since the materials themselves of the twisted thread 22b′ stretch, the tensile force becomes large (hereinafter, referred to as tensile ductility).

In addition, while the twisted thread 22b′ may be a yarn provided with many thin fibers twisted together, with a single thread provided with a plurality of such yarns twisted together, a difference in tensile force between the untwisted ductility and the tensile ductility preferably becomes large.

As has been described above, since the twisted thread 22b′ tends to stretch relatively easily in the stage of untwisted ductility, when the trim portion 20 of the opening trim weather strip 10 is mounted on the flange 7, the pliability of the trim portion 20 is increased, whereby the trim portion 20 is easily mounted on the flange 7 by being stretched along the configuration of the flange 7 while being deformed. As this occurs, since the force with which the trim portion 20 is stretched is not strong, the twisted thread 22b′ does not stretch over the untwisted ductility and does not stretch up to the tensile ductility. Therefore, when the trim portion 20 is mounted on the body opening portion 6, the stretch amount of the whole of the trim portion 20 is small, whereby the overall stretch of the weather strip in the longitudinal direction can be suppressed, there being thereby caused no case where wrinkles are produced in its ends.

In addition, the twisted thread 22b′ is embedded in such a manner as to coincide with the neutral plane N of the curve reliably when the trim portion 20 is mounted in the corner portion of the body opening portion 6. Because of this, although the exterior side wall 21 is curved in the width direction thereof when the trim portion 20 is mounted in the corner portion of the body opening portion 6, since the twisted thread 22b′ does not stretch, the twisted thread 22b′ coincides with the neutral plane N of the curve. Namely, in the corner portion, the portion of the exterior side wall 21 which lies further distal than this twisted thread 22b′ is caused to stretch, and the portion of the exterior side wall 21 which lies closer to the bottom wall 26 side than the twisted thread 22b′ is compressed, whereby the twisted thread 22b′ becomes neither stretched nor compressed.

Because of this, the bottom wall 26 is deflected in a direction in which it is brought into abutment with the distal edge of the flange 7, that is, the bottom wall 26 is deflected in such a manner that the angle of the L-shape cross section becomes acute, so that the bottom wall 26 is brought into pressure contact with the distal edge of the flange 7, whereby the sealing properties between the distal edge of the flange 7 and the bottom wall 26 are enhanced.

In addition, since the portion where the twisted thread 22b′ is embedded is formed thicker than a distal edge side portion of the exterior side wall 21. In this case, the portion where the twisted thread 22b′ is embedded coincides with the neutral plane N of the curve when the trim portion 20 is curved in a more ensured fashion.

In addition, a stepped exterior side wall projecting portion 24 is formed on an internal surface of the portion which is formed thick. When the pressure sensitive adhesive double coated tape 25 is securely affixed on the exterior side wall 21 in such a manner that a side edge thereof extends along a stepped side surface of the exterior side wall projecting portion 24, the positioning of the pressure sensitive adhesive double coated tape 25 can be implemented.

The continuous portion 27, which continues to both the exterior side wall 21 and the bottom wall 26, is formed integrally with the bottom wall 26 of a hard material whose hardness is in the range of IRHD 90 to 95. Although the exterior side wall 21 is curved in the width direction thereof when the trim portion 20 is mounted in the corner portion of the body opening portion 6, since the exterior side wall projecting portion 24 is formed of the hard material whose hardness is in the range of IRHD 90 to 95, the exterior side wall projection portion 24 coincides with the neutral plane N of the curve together with the twisted thread 22b′ as has been described above.

As the hard material, a hard rubber or hard synthetic resin can be used. As the hard rubber, a hard EPDM rubber whose hardness is in the range of IRHD 90 to 95 can be used, and as the hard synthetic resin, a hard polyethylene or hard polypropylene can be used. Furthermore, a hard olefin-based thermoplastic elastomer whose hardness is in the range of IRHD 90 to 95 can also be used.

These hard materials stretch and contract less in the longitudinal direction, and when the opening trim weather strip 10 is mounted on the flange 7, the opening trim weather strip 10 stretches less relative to the flange 7, so that there occurs no case where the opening trim weather strip 10 is partially separated or floated from the flange 7 or the opening trim weather strip 10 is wrinkled.

When forming an opening trim weather strip 10, in the event that as the hard material, the hard EPDM, hard polyethylene, hard polypropylene or the like is used for the portion that is to be formed of the hard material while the other portion is formed of a soft EPDM rubber or olefin-based thermoplastic elastomer which is softer than the hard material, both the materials can be formed simultaneously through extrusion using an extruding machine.

The portion of the exterior side wall 21 which lies further distal than the exterior side wall projecting portion 24 is formed of a material whose hardness is in the range of IRHD 65 to 70. Because of this, as has been described above, when the trim portion 20 is mounted in the corner portion to thereby be curved, the distal side of the exterior side wall 21 is caused to stretch, and the twisted thread 22b′ coincides with the neutral plane N of the curve reliably. In addition, since the exterior side wall 21 has a sufficient hardness, the configuration thereof is stabilized, and the exterior side wall 21 can hold the hollowed seal portion 30, which will be described later on, securely so as to secure the sealing properties.

The bottom wall 26 extends from the exterior side wall 21 horizontally and substantially perpendicularly thereto in such a manner as to be formed into a substantially flat plate shape and is formed of a hard material. The hard material is formed continuously and integrally from the exterior side wall projecting portion 24 on the exterior side wall 21, via the continuous portion 27, to the distal edge of the bottom wall 26.

Because of this, even though the distal edge of the flange 7 is brought into abutment with the bottom wall 26 in such a manner as to push it at the straight-line portion, there scarcely occurs a case where the bottom wall 26 is deformed and the angle between the bottom wall 26 and the exterior side wall 21 is increased, whereby the sealing properties can be secured. In addition, a position where the exterior side wall 21 is caused to adhere to the flange 7 can be determined, whereby the exterior side wall 21 can be caused to adhere to the flange 7 reliably.

In addition, an insulation sponge 28, which is an insulation member, is provided on a surface of the bottom wall 26 with which the flange 7 is brought into abutment. In this embodiment, the insulation sponge 28 is formed into a triangular hollowed shape and a distal edge of the insulation sponge 28 which lies on a root side of the bottom wall 26 is jointed to the bottom wall 26 in such a manner as to deviate slightly towards the distal edge side of the bottom wall 26. A portion on the bottom wall 26 where the insulation sponge 28 is not provided constitutes a bottom wall stepped portion 29. Because of this, the distal edge of the outer panel 9 of the flange 7, which is formed slightly longer than the other portions, can be brought into direct abutment with the bottom wall stepped portion 29 on the bottom wall 26, whereby not only the positioning of the flange 7 can be implemented but also the position on the exterior side wall 21 where the pressure sensitive adhesive double coated tape 25 thereon is caused to adhere to the flange 7 can be determined. Note that the bottom wall stepped portion 29 may be formed into an L-shaped stepped shape in cross section on the bottom wall 26.

In addition, since the insulation sponge 28 is formed of a sponge material, portions of the flange 7 other than the portion provided with the distal edge of the outer panel 9 are embedded in the insulation sponge 28 so as to encapsulate the distal edge of the flange. Because of this, in the event that the flange 7 is made through spot welding or the like, although gaps are produced between the individual plates which make up the flange 7, the leakage of noise and rain water from the gaps in the distal edges of the constituent metal plates of the flange 7 can be prevented. In addition, dust and noise which would otherwise intrude from the outside into the interior of the vehicle by passing through between the distal edge of the flange 7 and the bottom wall 26 can also be sealed out.

The hollowed seal portion 30 is formed integrally on an external surface of the exterior side wall 21. The hollowed seal portion 30 is formed of a hollow sponge material of a substantially oval cross section on the external surface of the exterior side wall 21. A sponge rubber, a sponge thermoplastic elastomer or the like is sued for the sponge material. The hollowed seal portion 30 is, when the door is closed, brought into abutment with, for example, the door frame extending portion 2a of the door 2 so as to form a seal between the door 2 and the body opening portion 6. A garnish may be provided in such a manner as to cover a side edge of the hollowed seal 30 and the bottom wall 26, whereby the flange 7 and the bottom wall 26 can be covered by the garnish 40 so as to enhance the aesthetic external appearance of the body opening.

When the opening trim weather strip 10 of the embodiment of the invention is mounted on the flange 7, firstly, the trim portion 20 of the opening trim weather strip 10 is positioned obliquely relative to the flange 7, so that the distal edge of the flange 7 is brought into abutment with the bottom wall 26. As this occurs, since no internal side wall is provided on the trim portion 20, the flange 7 can be inserted into the trim portion 20 while being inclined obliquely relative to the trim portion 20.

As this occurs, since the outer panel 9 of the flange 7 is slightly longer than the other panels, the distal edge of the outer panel 9 is brought into abutment with the bottom wall stepped portion 29 on the bottom wall 26. Then, a side surface of the outer panel 9 is brought into abutment with the exterior side wall projecting portion 24 of the exterior side wall 21.

Thereafter, the trim portion 20 is rotated, so that the pressure sensitive adhesive double coated tape 25 is pushed against the side surface of the flange 7. Then, the hollowed seal portion 30 is pressed by a roller, so that the pressure sensitive adhesive double coated tape 25 is caused to adhere to the flange 7.

Next, a production method of the opening trim weather strip 10 will be described.

The opening trim weather strip is formed through extrusion, and a solid rubber which makes up the trim portion 20 and a sponge which makes up the hollowed seal portion 30 can be extruded integrally using an extruding machine.

When the reinforcing thread material 22b is embedded in the stretch and contraction prevention portion 22 (when the twisted thread 22b′ is embedded in the exterior side wall projecting portion 24 of the exterior side wall 21 in the fourth embodiment), the reinforcing thread material 22b (or the twisted thread 22b′) can be extruded together with the trim portion 20 and the hollowed seal portion 30.

In extrusion of the opening trim weather strip, as the material of which it is made, a hard synthetic rubber or a hard synthetic resin (hard thermoplastic elastomer) is used as the hard material, while an EPDM rubber is used for a synthetic rubber, and a polyolefin-based elastomer is used for a thermoplastic elastomer. As the sponge material, the EPDM rubber and thermoplastic elastomer are expanded for use.

In the case of the synthetic rubber, it is transferred to a vulcanizing tank after extrusion, where the synthetic rubber is heated to be vulcanized and expanded by hot air or high-frequency wave. In the case of the hard synthetic resin (thermoplastic elastomer) or the soft synthetic resin, it is heated to be expanded at the same time as or after extrusion and is then cooled for setting. Thereafter, the set material is cut to a predetermined length, whereby the production of an extruded portion is completed.

The extruded opening trim weather strip 10 is cut to a predetermined length and may then be connected through molding to be formed into a ring shape for mounting on the flange 7 of the body opening portion of an automobile.

What is claimed is:

1. A weather strip for establishing a seal between an open/close member and a body opening portion in an automobile, comprising:
a mounting base portion mounted on a flange provided on either of the open/close member and the body opening portion and a seal portion provided integrally on the mounting base portion and adapted to be brought into abutment with the other of the open/close member and the body opening portion so as to establish a seal between the open/close member and the body opening portion,
wherein the mounting base portion includes a portion formed into a substantially L-shape in cross section which has at least a bottom wall and an exterior side wall, and
a pressure sensitive adhesive double coated tape is affixed to an internal surface of the exterior side wall, a stretch and contraction prevention portion is formed on the exterior side wall in a position in the exterior side wall so as to be adjacent to a connecting portion between the exterior side wall and the bottom wall, and
when the mounting base portion is curved in the width direction, a neutral plane N of the curve is made to coincide within the stretch and contraction prevention portion.

2. A weather strip according to claim 1, wherein the stretch and contraction prevention portion is formed of a hard material and thicker than any other portions of the exterior side wall.

3. A weather strip according to claim 1, wherein a reinforcing thread material or metal wire is embedded in the stretch and contraction prevention portion.

4. A weather strip according to claim 1, wherein the stretch and contraction prevention portion on the exterior side wall and the bottom wall are formed of the same material whose hardness is in the range of IRHD 90 to 95, and other portions of the exterior side wall than the stretch and contraction prevention portion are formed of a hard material whose hardness is in the range of IRHD 65 to 75.

5. A weather strip according to claim 1, wherein almost all the exterior side wall and the bottom wall are formed of the same material whose hardness is in the range of IRHD 70 to 80.

6. A weather strip according to claim 1, wherein the weather strip is formed into a ring shape so as to match the shape of the flange by connecting together both ends of a rectilinearly extruded weather strip, and wherein a connecting portion where both the ends are connected together is formed of a material which is softer than other portions of the extruded weather strip.

7. A weather strip according to claim 1, wherein the open/close member is a door, and the weather strip is an opening trim weather strip.

8. A weather strip according to claim 1, wherein a twisted thread which coincides with a neutral plane N of the curve when the mounting base portion is curved in the width direction is embedded continuously in the mounting base portion along a longitudinal direction of the mounting base portion.

9. A weather strip according to claim 8, wherein the weather strip is mounted on the flange provided on either of the open/close member and the body opening portion such that the twist of the twisted thread which is embedded in the mounting base portion is stretched.

10. A weather strip according to claim 8, wherein the twisted thread is a single thread made by twisting together a plurality of yarns each of which is provided with a number of thin fibers twisted together.

11. A weather strip according to claim 8, wherein the twisted thread lies more centrally in a width direction of the exterior side wall than a connecting portion where the exterior side wall and the bottom wall are connected together.

12. A weather strip according to claim 8, wherein the twisted thread is provided with polyester fibers, Vinylon fibers or nylon fibers.

13. A weather strip according to claim 8, wherein a portion of the exterior side wall where the twisted thread is embedded is formed of a hart rubber material or thermoplastic elastomer and is formed thicker than other portions of the exterior side wall.

14. A weather strip according to claim 8, wherein a stretch and contraction prevention portion which is the portion of the exterior side wall where the twisted thread is embedded and the bottom wall are formed of a hard material whose hardness is in the range of IRHD 90 to 95, and the other portions of the exterior side wall than the stretch and contraction prevention portion are formed of a material whose hardness is in the range of IRHD 65 to 75.

15. A weather strip according to claim 8, wherein the open/close member is a door, and the weather strip is an opening trim weather strip.
